(19) United States
(12) Patent Application Publication
(10) Pub. No.: US 2010/0039423 A1
(43) Pub. Date: Feb. 18, 2010

(54) SCAN DRIVER AND ORGANIC LIGHT EMITTING DISPLAY USING THE SAME

(76) Inventors: Jin-Tae Jeong, Yongin-city (KR); Ki-Myeong Eom, Yongin-city (KR); Seon-I Jeong, Yongin-city (KR)

Correspondence Address: CHRISTIE, PARKER & HALE, LLP, PO BOX 7068, PASADENA, CA, 91109-7068, US

(21) Appl. No.: 12/537,881

(22) Filed: Aug. 7, 2009

(30) Foreign Application Priority Data
Aug. 14, 2008 (KR) 10-2008-0079876

(51) Int. Cl. G06F 3/038

(52) U.S. Cl. 345/213; 345/82

(57) ABSTRACT

An organic light emitting display generates scan signals with a scan driver that includes a plurality of stages. A first stage among the plurality of stages includes a first signal processor receiving a start pulse and a second clock to generate a first output signal, a second signal processor receiving the start pulse and a first clock to generate a second output signal, a third signal processor receiving the first output signal, the second output signal, and a third clock to generate a first scan signal, and a fourth signal processor receiving the first output signal, the second output signal, and a fourth clock to generate a second scan signal.

### CROSS-REFERENCE TO RELATED APPLICATION

This application claims priority to and the benefit of Korean Patent Application No. 10-2008-0079876, filed on Aug. 14, 2008, in the Korean Intellectual Property Office, the entire content of which is incorporated herein by reference.

### BACKGROUND OF THE INVENTION

1. Field of the Invention

The present invention relates to a scan driver and an organic light emitting display using the same.

2. Description of the Related Art

Recently, various flat panel displays (FPDs) having less weight and volume than cathode ray tubes (CRTs) have been developed. The FPDs include liquid crystal displays (LCDs), field emission displays (FEDs), plasma display panels (PDPs), and organic light emitting displays.

Among the FPDs, an organic light emitting display displays images using organic light emitting diodes (OLEDs) that generate light by re-combination of electrons and holes generated in response to a flow of current. The organic light emitting display is widely used in personal digital assistants (PDAs) and MP3 players as well as in mobile telephones due to various advantages such as high color reproducibility and small thickness.

The above-described organic light emitting display includes a matrix of pixels, each with an OLED. The pixels are accessed by scan signals on scan lines running across the matrix of pixels in a row direction. Data signals are supplied to the pixels by data lines running across the matrix of pixels in a column direction. The scan signals are generated by a scan driver, and the data signals are generated by a data driver. The scan driver that generates the scan signals includes a plurality of stages, each of which generates one scan signal.

Recently, as high-resolution image signals are being used to display images, the number of scan lines that convey the scan signals has been increasing. However, there are limitations to increasing the number of scan lines, such as the size of the circuit required to generate the scan signals.

### SUMMARY OF THE INVENTION

Accordingly, an exemplary embodiment of the present invention provides a scan driver in which the area of a circuit that outputs scan signals is reduced so that the size of the scan driver is reduced.

An exemplary embodiment of the present invention provides a scan driver including a plurality of stages, a first stage of the plurality of stages including: a first signal processor for receiving a start pulse and a second clock for generating a first output signal; a second signal processor for receiving the start pulse and a first clock for generating a second output signal; a third signal processor for receiving the first output signal, the second output signal, and a third clock for generating a first scan signal; and a fourth signal processor for receiving the first output signal, the second output signal, and a fourth clock for generating a second scan signal.

Another exemplary embodiment of the present invention provides an organic light emitting display including: a display unit for displaying an image in response to data signals and scan signals; a data driver for generating the data signals; and a scan driver for generating the scan signals, the scan driver including a plurality of stages, a first stage of the plurality of stages including: a first signal processor for receiving a start pulse and a second clock for generating a first output signal; a second signal processor for receiving the start pulse and a first clock for generating a second output signal; a third signal processor for receiving the first output signal, the second output signal, and a third clock for generating a first scan signal of the scan signals; and a fourth signal processor for receiving the first output signal, the second output signal, and a fourth clock for generating a second scan signal of the scan signals.

Another exemplary embodiment of the present invention provides a scan driver including a plurality of stages, a first stage of the plurality of stages including: a first signal processor for receiving a start pulse and a second clock for generating a first output signal; a second signal processor for receiving the start pulse and a first clock for generating a second output signal; a third signal processor for receiving the first output signal, the second output signal, and a third clock for generating a first scan signal; a fourth signal processor for receiving the first output signal, the second output signal, and a fourth clock for generating a second scan signal; and a fifth signal processor for receiving the first output signal, the second output signal, and a fifth clock for generating a third scan signal.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic diagram of the structure of an organic light emitting display according to aspects of the present invention;

FIG. 2 is a schematic diagram of a first embodiment of a scan driver included in the organic light emitting display of FIG. 1;

FIG. 3 is a schematic circuit diagram of the scan driver of FIG. 2;

FIG. 4 is a waveform diagram of signals of the scan driver of FIG. 3; and

FIG. 5 is a schematic diagram of a second embodiment of a scan driver included in the organic light emitting display of FIG. 1.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or may be indirectly coupled to the second element via a third element. Further, some of the elements that are not essential to a complete understanding of the invention are omitted for clarity. Also, like reference numerals refer to like elements throughout.

In the following, exemplary embodiments of the present invention will be described with reference to the accompanying drawings.

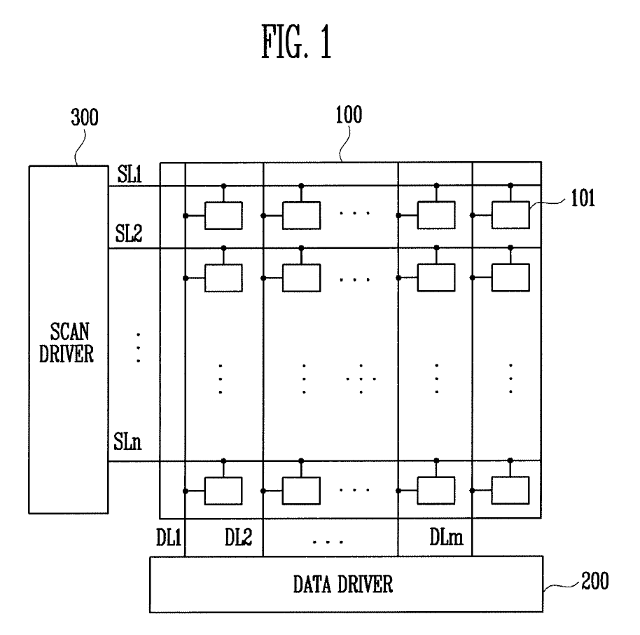

FIG. 1 illustrates the structure of an organic light emitting display according to an exemplary embodiment of the present invention. Referring to FIG. 1, the organic light emitting display includes a display unit 100, a data driver 200, and a scan driver 300.

A plurality of pixels 101 are arranged in the display unit 100 and each of the pixels 101 includes an organic light emitting diode (OLED) that emits light in response to a flow of current. The display unit 100 includes n scan lines SL1, SL2, . . . , and SLn that transmit scan signals in a row direction and m data lines DL1, DL2, . . . , and DLm that transmit data signals in a column direction.

In addition, the display unit 100 receives a pixel power source and a base power source. Current flows through the OLED controlled by the scan signals, the data signals, the pixel power source, and the base power source in the display unit 100 so that the display unit 100 emits light to display an image.

The data driver 200 generates data signals using image signals having red, blue, and green components. The data driver 200 is coupled to the data lines DL1, DL2, . . . , and DLm of the display unit 100 to apply the generated data signals to the display unit 100.

The scan driver 300 that generates scan signals is coupled to the scan lines SL1, SL2, . . . , and SLn to transmit the scan signals to specific rows of the display unit 100. The data signals output from the data driver 200 are also transmitted to the pixels 101 to which the scan signals are transmitted so that voltages corresponding to the data signals are transmitted to the pixels 101.

The scan driver 300 generates the scan signals by a plurality of stages so that at least two scan signals are output from each of the stages. Therefore, the number of stages is reduced so that the size of the scan driver 300 can be reduced.

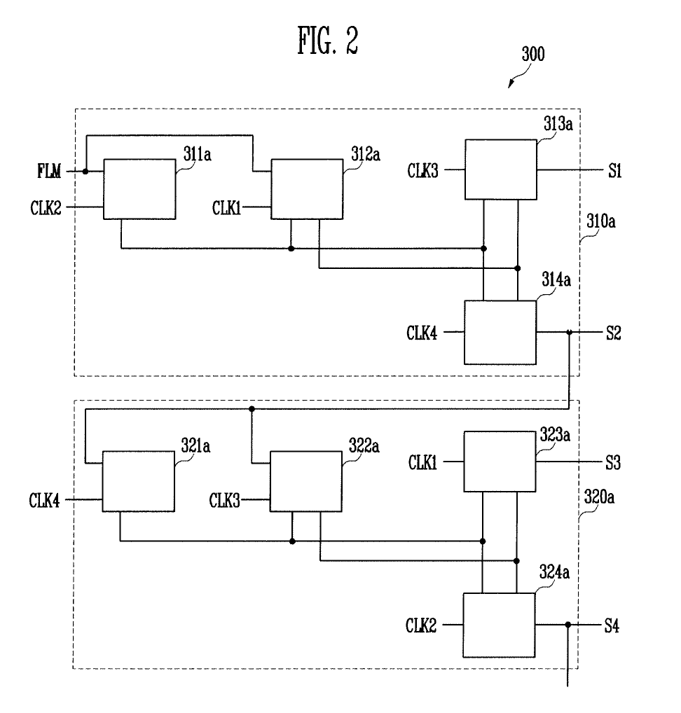

FIG. 2 illustrates a first embodiment of a scan driver included in the organic light emitting display of FIG. 1. Referring to FIG. 2, the scan driver 300 includes a plurality of stages, each of which receives first to fourth clocks CLK1 to CLK4 and a start pulse FLM or a scan signal of a previous stage. In addition, the stages include first to fourth signal processors 311a, 312a, 313a, and 314a, and 321a, 322a, 323a, and 324a. For convenience in the description of the scan driver 300, FIG. 2 shows only a first stage 310a and a second stage 320a.

The first signal processor 311a of the first stage 310a receives the start pulse FLM and the second clock CLK2. The second signal processor 312a receives the start pulse FLM and the first clock CLK1. The third signal processor 313a receives an output signal of the first signal processor 311a, an output signal of the second signal processor 312a, and the third clock CLK3 and outputs the first scan signal S1 on the first scan line SL1. The fourth signal processor 314a receives the output signal of the first signal processor 311a, the output signal of the second signal processor 312a, and the fourth clock CLK4 and outputs the second scan signal S2 on the second scan line SL2.

The first signal processor 321a of the second stage 320a receives the second scan signal S2 and the fourth clock CLK4. The second signal processor 322a receives the second scan signal S2 and the third clock CLK3. The third signal processor 323a receives the output signal of the first signal processor 321a, the output signal of the second signal processor 322a, and the first clock CLK1 and outputs the third scan signal S3 on the third scan line SL3. The fourth signal processor 324a receives the output signal of the first signal processor 321a, the output signal of the second signal processor 322a, and the second clock CLK2 and outputs the fourth scan signal S4 on the fourth scan line SL4.

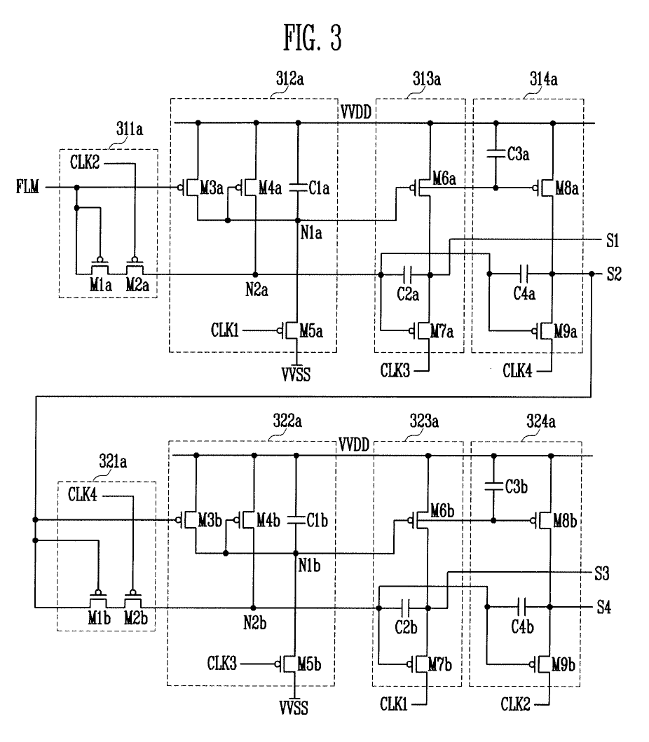

FIG. 3 is a schematic circuit diagram illustrating the scan driver of FIG. 2. Referring to FIG. 3, the first signal processor 311a of the first stage includes a first transistor M1a and a second transistor M2a. The start pulse FLM is coupled to the drain and the gate of the first transistor M1a. The source of the first transistor M1a is coupled to the drain of the second transistor M2a. The gate of the second transistor M2a receives the second clock CLK2, and the source of the second transistor M2a is coupled to a second node N2a.

The second signal processor 312a of the first stage 310a includes a third transistor M3a, a fourth transistor M4a, a fifth transistor M5a, and a first capacitor C1a. The third transistor M3a has its source coupled to a first power source VVDD that supplies a high level voltage, its drain coupled to a first node N1a, and its gate receives the start pulse FLM. The fourth transistor M4a has its source coupled to the first power source VVDD, its drain coupled to the second node N2a, and its gate coupled to the first node N1a. The fifth transistor M5a has its source coupled to the first node N1a, its drain coupled to a second power source VVSS that supplies a low level voltage, and its gate receiving the first clock CLK1. In addition, the first capacitor C1a has its first electrode coupled to the first power source VVDD and its second electrode coupled to the first node N1a.

The third signal processor 313a of the first stage 310a includes the sixth transistor M6a, a seventh transistor M7a, and a second capacitor C2a. The sixth transistor M6a has its source coupled to the first power source VVDD, its drain coupled to the first scan line SL1 for applying the first scan signal S1, and its gate coupled to the first node N1a. The seventh transistor M7a has its drain coupled to the third clock CLK3, its source coupled to the first scan line SL1, and its gate coupled to the second node N2a. The second capacitor C2a has its first electrode coupled to the second node N2a and its second electrode coupled to the first scan line SL1.

The fourth signal processor 314a of the first stage 310a includes an eighth transistor M8a, a ninth transistor M9a, a third capacitor C3a, and a fourth capacitor C4a. The eighth transistor M8a has its source coupled to the first power source VVDD, its drain coupled to the second scan line SL2 for applying the second scan signal S2, and a gate coupled to the first node N1a. The ninth transistor M9a has its drain coupled to the fourth clock CLK4, its source coupled to the second scan line SL2, and its gate coupled to the second node N2a. The third capacitor C3a has its first electrode coupled to the first power source VVDD and its second electrode coupled to the gate of the eighth transistor M8a. In addition, the fourth capacitor C4a has its first electrode coupled to the second node N2a and its second electrode coupled to the second scan line SL2.

The first signal processor 321a of the second stage 320a includes a first transistor M1b and a second transistor M2b. The second scan signal S2 output from the fourth signal processor 314a of the first stage 310a is coupled to the drain and the gate of the first transistor M1b. The source of the first transistor M1b is coupled to the drain of the second transistor M2b. The gate of the second transistor M2b receives the fourth clock CLK4, and the source of the second transistor M2b is coupled to a second node N2b.

The second signal processor 322a of the second stage 320a includes a third transistor M3b, a fourth transistor M4b, a fifth transistor M5b, and a first capacitor C1b. The third transistor M3b has its source coupled to the first power source VVDD, its drain coupled to a first node N1b, and its gate receives the second scan signal S2. The fourth transistor M4b has its source coupled to the first power source VVDD, its drain coupled to the second node N2b, and its gate coupled to the first node N1b. The fifth transistor M5b has its source coupled to the first node N1b, its drain coupled to the second power source VVSS, and its gate receiving the third clock CLK3. In addition, the first capacitor C1b has its first electrode coupled to the first power source VVDD and its second electrode coupled to the first node N1b.

The third signal processor 323a of the second stage 320a includes a sixth transistor M6b, a seventh transistor M7b, and a second capacitor C2b. The sixth transistor M6b has its source coupled to the first power source VVDD, its drain coupled to the third scan line SL3 for applying the third scan signal S3, and its gate coupled to the first node N1b. The seventh transistor M7b has its drain coupled to the first clock CLK1, its source coupled to the third scan line SL3, and its gate coupled to the second node N2b. The second capacitor C2b has its first electrode coupled to the second node N2b and its second electrode coupled to the third scan line SL3.

The fourth signal processor 324a of the second stage 320a includes an eighth transistor M8b, a ninth transistor M9b, a third capacitor C3b, and a fourth capacitor C4b. The eighth transistor M8b has its source coupled to the first power source VVDD, its drain coupled to the fourth scan line SL4 for applying the fourth scan signal S4, and its gate coupled to the first node N1b. The ninth transistor M9b has its drain coupled to the second clock CLK2, its source coupled to the fourth scan line SL4, and its gate coupled to the second node N2b. The first electrode of the third capacitor C3b is coupled to the first power source VVDD, and the second electrode of the third capacitor C3b is coupled to the gate of the eighth transistor M8b. In addition, the first electrode of the fourth capacitor C4b is coupled to the second node N2b, and the second electrode of the fourth capacitor C4b is coupled to the fourth scan line SL4.

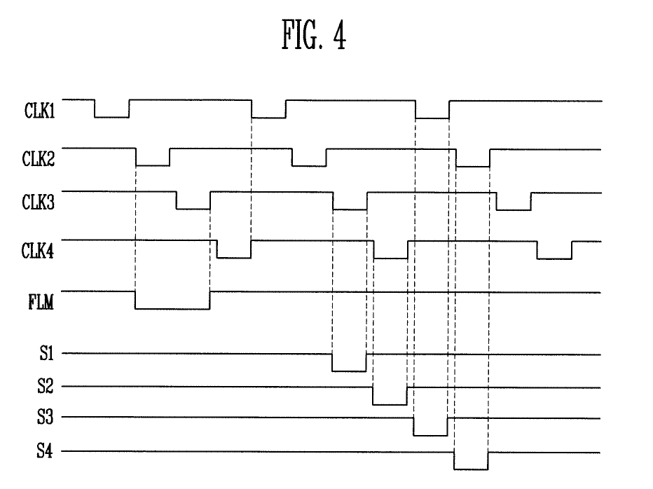

FIG. 4 illustrates waveforms of signals input to and output from the scan driver of FIG. 3. FIG. 4 will be described with reference to FIG. 3. First, the first clock CLK1 is at a low level and the second clock CLK2, the third clock CLK3, the fourth clock CLK4, and the start pulse FLM are at a high level. In the first stage 310a, the fifth transistor M5a is turned on by the first clock CLK1. When the fifth transistor M5a is turned on, the first node N1a is pulled toward the voltage of the second power source VVSS. Since the voltage of the second power source VVSS is at a low level, the sixth transistor M6a and the eighth transistor M8a are turned on so that the first and second scan signals S1 and S2 output through the first and second scan lines are at a high level.

Then the second clock CLK2 and the start pulse FLM are at a low level and the first clock CLK1, the third clock CLK3, and the fourth clock CLK4 are at a high level. The first transistor M1a and the third transistor M3a are turned on by the low level of the start pulse FLM. The second transistor M2a is turned on by the low level of the second clock CLK2. Therefore, the first power source VVDD, having a high level, is transmitted to the first node N1a. When a voltage from the first power source VVDD is transmitted to the first node N1a, the sixth transistor M6a and the eighth transistor M8a are turned off. The low level of the start pulse FLM has transmitted through diode-connected first transistor M1a and the second transistor M2a to the second node N2a. Since the start pulse FLM has a low level, the second node N2a is also at a low level. When the second node N2a is at a low level, the seventh transistor M7a and the ninth transistor M9a are turned on. Since the third clock CLK3 and the fourth clock CLK4 are at a high level, the first and second scan signals S1 and S2 output through the first and second scan lines are at a high level.

Then the first clock CLK1, the second clock CLK2, and the fourth clock CLK4 are at a high level and the third clock CLK3 and the start pulse FLM are at a low level. The first node N1a is maintained at a high level by the third transistor M3a so that the sixth transistor M6a and the eighth transistor M8a are turned off. The second node N2a is maintained at a low level by the second capacitor C2a and the fourth capacitor C4a. When the second node N2a is maintained at a low level, the seventh transistor M7a and the ninth transistor M9a are turned on. Since the third clock CLK3 is at a low level and the fourth clock CLK4 is at a high level, the first scan signal S1 output through the first scan line is at a low level and the second scan signal S2 output through the second scan line is at a high level. During the transition of the third clock signal from a high level to a low level, the second capacitor C2a serves as a bootstrap capacitor. It drives the gate of the seventh transistor M7a to a more negative voltage thereby accelerating the falling edge of the first scan signal S1 and avoiding a threshold voltage drop between the first scan signal S1 and the third clock CLK3.

Then the first clock CLK1, the second clock CLK2, the third clock CLK3, and the start pulse FLM are at a high level and the fourth clock CLK4 is at a low level. The first node N1a is maintained by the first capacitor C1a and the third capacitor C3a at a high level so that the sixth transistor M6a and the eighth transistor M8a are turned off. The second node N2a is maintained at a low level by the second capacitor C2a and the fourth capacitor C4a. When the second node N2a is at a low level, the seventh transistor M7a and the ninth transistor M9a are turned on. Since the third clock CLK3 is at a high level and the fourth clock CLK4 is at a low level, the first scan signal S1 output through the first scan line is at a high level, and the second scan signal S2 output through the second scan line is at a low level. During the transition of the fourth clock signal CLK4 from a high level to a low level, the fourth capacitor C4a serves as a bootstrap capacitor as described above for the second capacitor C2a.

Above, it was described that the start pulse FLM is at a low level in periods where the second clock CLK2 and the third clock CLK3 are at a low level. However, the start pulse FLM can be at a low level only in the period where the second clock CLK2 is at a low level.

The second stage 320a has the same structure as the first stage 310a and receives the second scan signal S2 output from the first stage 310a through the second scan line instead of the start pulse FLM to operate. The first node N1b is initialized by the third clock CLK3. The second scan signal S2 is transmitted to the second node N2b by the fourth clock CLK4. The third scan signal S3 is output by the first clock CLK1 on the third scan line. The fourth scan signal S4 is output by the second clock CLK2 on the fourth scan line.

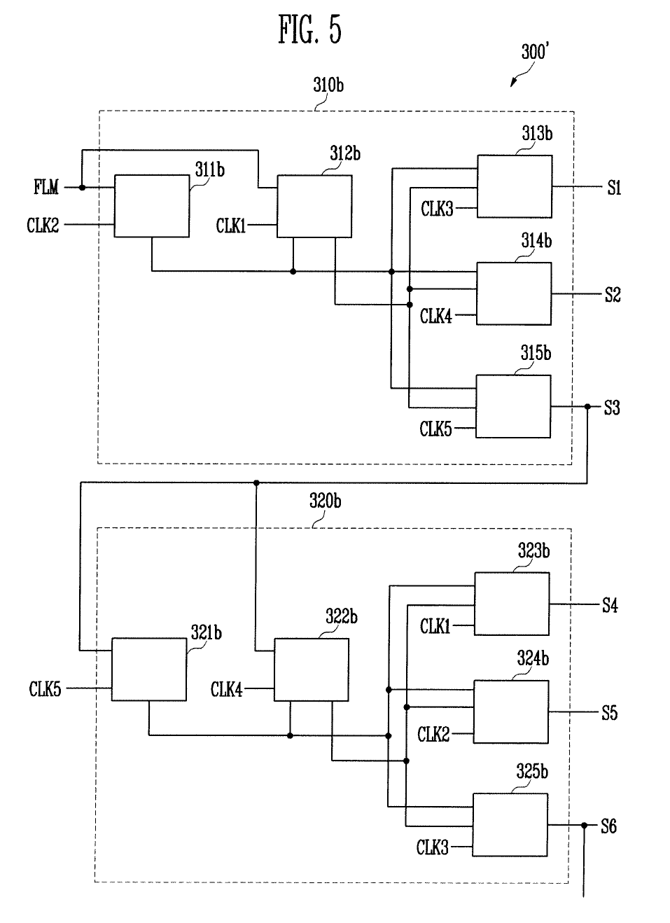

FIG. 5 illustrates the structure of a second embodiment of a scan driver included in the organic light emitting display of FIG. 1. Referring to FIG. 5, a scan driver 300′ includes a plurality of stages, each of which receives first to fifth clocks CLK1 to CLK5 and a start pulse FLM or an output signal of a previous stage. In addition, each of the stages includes first to fifth signal processors. For convenience sake in the description of the scan driver 300′, FIG. 5 shows only a first stage 310b and a second stage 320b.

The first signal processor 311b of the first stage 310b receives the start pulse FLM and the second clock CLK2. The second signal processor 312b of the first stage 310b receives the start pulse FLM and the first clock CLK1. The third signal processor 313b of the first stage 310b receives the output signal of the first signal processor 311b, the output signal of the second signal processor 312b, and the third clock CLK3 to output the first scan signal S1. The fourth signal processor 314b of the first stage 310b receives the output signal of the first signal processor 311b, the output signal of the second signal processor 312b, and the fourth clock CLK4 to output the second scan signal S2. In addition, the fifth signal processor 315b receives the output signal of the first signal processor 311b, the output signal of the second signal processor 312b, and the fifth clock CLK5 to output the third scan signal S3.

The first signal processor 321b of the second stage 320b receives the third scan signal S3 and the fifth clock CLK5. The second signal processor 322b of the second stage 320b receives the third scan signal S3 and the fourth clock CLK4. The third signal processor 323b of the second stage 320b receives the output signal of the first signal processor 321b, the output signal of the second signal processor 322b, and the first clock CLK1 to output the fourth scan signal S4. The fourth signal processor 324b of the second stage 320b receives the output signal of the first signal processor 321b, the output signal of the second signal processor 322b, and the second clock CLK2 to output the fifth scan signal S5. In addition, the fifth signal processor 325b of the second stage 320b receives the output signal of the first signal processor 321b, the output signal of the second signal processor 322b, and the third clock CLK3 to output the sixth scan signal S6.

The first signal processors 311b, 321b may be circuits as shown in FIG. 3 for the first signal processors 311a, 321a. The second signal processors 312b, 322b may be circuits as shown in FIG. 3 for the second signal processors 312a, 322a. The third signal processors 313b, 323b may be circuits as shown in FIG. 3 for the third signal processors 313a, 323a. The fourth signal processors 314b, 324b may be circuits as shown in FIG. 3 for the third signal processors 313a, 323a. The fifth signal processors 315b, 325b may be circuits as shown in FIG. 3 for the fourth signal processors 314a, 324a.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A scan driver comprising a plurality of stages,
a first stage of the plurality of stages comprising:
a first signal processor for receiving a start pulse and a second clock for generating a first output signal;
a second signal processor for receiving the start pulse and a first clock for generating a second output signal;
a third signal processor for receiving the first output signal, the second output signal, and a third clock for generating a first scan signal; and
a fourth signal processor for receiving the first output signal, the second output signal, and a fourth clock for generating a second scan signal.

2. The scan driver as claimed in claim 1, wherein a second stage of the plurality of stages comprises:
a first signal processor for receiving the second scan signal and the fourth clock for generating a third output signal;
a second signal processor for receiving the second scan signal and the third clock for generating a fourth output signal;
a third signal processor for receiving the third output signal, the fourth output signal, and the first clock for generating a third scan signal; and
a fourth signal processor for receiving the third output signal, the fourth output signal, and the second clock for generating a fourth scan signal.

3. The scan driver as claimed in claim 1, wherein the first signal processor comprises:
a first transistor having a drain and a gate coupled to the start pulse; and
a second transistor having a drain coupled to a source of the first transistor, a gate coupled to the second clock, and a source coupled to the first output signal.

4. The scan driver as claimed in claim 1, wherein the second signal processor comprises:
a third transistor having a source coupled to a first power source, a drain coupled to the second output signal, and a gate coupled to the start pulse;
a fourth transistor having a source coupled to the first power source, a drain coupled to the first output signal, and a gate coupled to the second output signal;
a fifth transistor having a drain coupled to a second power source, a source coupled to the second output signal, and a gate coupled to the first clock; and
a first capacitor having a first electrode coupled to the first power source and a second electrode coupled to the second output signal.

5. The scan driver as claimed in claim 1, wherein the third signal processor comprises:
a sixth transistor having a source coupled to a first power source, a drain coupled to a first scan line for applying the first scan signal, and a gate coupled to the second output signal;
a seventh transistor having a source coupled to the first scan line, a drain coupled to the third clock, and a gate coupled to the first output signal; and
a second capacitor having a first electrode coupled to the first scan line and a second electrode coupled to the first output signal.

6. The scan driver as claimed in claim 1, wherein the fourth signal processor comprises:
an eighth transistor having a source coupled to a first power source, a drain coupled to a second scan line for applying the second scan signal, and a gate coupled to the second output signal;
a ninth transistor having a source coupled to the second scan line, a drain coupled to the fourth clock, and a gate coupled to the first output signal;
a third capacitor having a first electrode coupled to the first power source and a second electrode coupled to the gate of the eighth transistor; and
a fourth capacitor having a first electrode coupled to the second scan line and a second electrode coupled to the first output signal.

7. The scan driver as claimed in claim 6, wherein the second scan line is an input to a second stage of the plurality of stages.

8. An organic light emitting display comprising:
a display unit for displaying an image in response to data signals and scan signals;
a data driver for generating the data signals; and
a scan driver for generating the scan signals,
the scan driver comprising a plurality of stages,
a first stage of the plurality of stages comprising:
a first signal processor for receiving a start pulse and a second clock for generating a first output signal;
a second signal processor for receiving the start pulse and a first clock for generating a second output signal;
a third signal processor for receiving the first output signal, the second output signal, and a third clock for generating a first scan signal of the scan signals; and
a fourth signal processor for receiving the first output signal, the second output signal, and a fourth clock for generating a second scan signal of the scan signals.

9. The organic light emitting display as claimed in claim 8, wherein a second stage of the plurality of stages comprises:
a first signal processor for receiving the second scan signal and the fourth clock for generating a third output signal;
a second signal processor for receiving the second scan signal and the third clock for generating a fourth output signal;
a third signal processor for receiving the third output signal, the fourth output signal, and the first clock for generating a third scan signal of the scan signals; and
a fourth signal processor for receiving the third output signal, the fourth output signal, and the second clock for generating a fourth scan signal of the scan signals.

10. The organic light emitting display as claimed in claim 8, wherein the first signal processor comprises:
a first transistor having a drain and a gate coupled to the start pulse; and
a second transistor having a drain coupled to a source of the first transistor, a gate coupled to the second clock, and a source coupled to the first output signal.

11. The organic light emitting display as claimed in claim 8, wherein the second signal processor comprises:
a third transistor having a source coupled to a first power source, a drain coupled to the second output signal, and a gate coupled to the start pulse;
a fourth transistor having a source coupled to the first power source, a drain coupled to the first output signal, and a gate coupled to the second output signal;
a fifth transistor having a drain coupled to a second power source, a source coupled to the second output signal, and a gate coupled to the first clock; and
a first capacitor having a first electrode coupled to the first power source and a second electrode coupled to the second output signal.

12. The organic light emitting display as claimed in claim 8, wherein the third signal processor comprises:
a sixth transistor having a source coupled to a first power source, a drain coupled to the first scan signal, and a gate coupled to the second output signal;
a seventh transistor having a source coupled to the first scan signal, a drain coupled to the third clock, and a gate coupled to the first output signal; and
a second capacitor having a first electrode coupled to the first scan signal and a second electrode coupled to the first output signal.

13. The organic light emitting display as claimed in claim 8, wherein the fourth signal processor comprises:
an eighth transistor having a source coupled to a first power source, a drain coupled to the second scan signal, and a gate coupled to the second output signal;
a ninth transistor having a source coupled to the second scan signal, a drain coupled to the fourth clock, and a gate coupled to the first output signal;
a third capacitor having a first electrode coupled to a first power source and a second electrode coupled to the gate of the eighth transistor; and
a fourth capacitor having a first electrode coupled to the second scan signal and a second electrode coupled to the first output signal.

14. The organic light emitting display as claimed in claim 13, wherein the second scan signal is an input to a second stage of the plurality of stages.

15. A scan driver comprising a plurality of stages,
a first stage of the plurality of stages comprising:
a first signal processor for receiving a start pulse and a second clock for generating a first output signal;
a second signal processor for receiving the start pulse and a first clock for generating a second output signal;
a third signal processor for receiving the first output signal, the second output signal, and a third clock for generating a first scan signal;
a fourth signal processor for receiving the first output signal, the second output signal, and a fourth clock for generating a second scan signal; and
a fifth signal processor for receiving the first output signal, the second output signal, and a fifth clock for generating a third scan signal.

16. The scan driver as claimed in claim 15, wherein a second stage of the plurality of stages comprises:
a first signal processor for receiving the third scan signal and the fifth clock for generating a third output signal;
a second signal processor for receiving the third scan signal and the fourth clock for generating a fourth output signal;
a third signal processor for receiving the third output signal, the fourth output signal, and the first clock for generating a fourth scan signal;
a fourth signal processor for receiving the third output signal, the fourth output signal, and the second clock for generating a fifth scan signal; and
a fifth signal processor for receiving the third output signal, the fourth output signal, and the third clock for generating a sixth scan signal.
